(19) United States
(12) Patent Application Publication
(10) Pub. No.: US 2011/0114433 A1
(43) Pub. Date: May 19, 2011

(54) TORQUE CONVERTER APPARATUS

(75) Inventors: Yasuaki HATTORI, Kariya-shi (JP); Takahiro Misu, Nagoya-shi (JP); Yukihisa Tsuzuki, Kariya-shi (JP); Naohisa Tsuzuki, Kariya-shi (JP); Yasuhiro Kobayashi, Anjo-shi (JP); Yosuke Makino, Anjo-shi (JP); Tomoko Yamamoto, Chiryu-shi (JP); Tomoyuki Kitagawa, Anjo-shi (JP)

(73) Assignee: AISIN SEIKI KABUSHIKI KAISHA, Kariya-shi (JP)

(21) Appl. No.: 12/944,170

(22) Filed: Nov. 11, 2010

(30) Foreign Application Priority Data
Nov. 17, 2009 (JP) 2009-261703
Nov. 17, 2009 (JP) 2009-261704

(51) Int. Cl. F16H 45/02

(52) U.S. Cl. 192/3.29; 192/3.28

(57) ABSTRACT

A torque converter apparatus includes a torque converter having a torus-shaped element, and an impeller clutch transmitting and disconnecting a driving force of an engine to and from an input element of the torque converter, the impeller clutch arranged at a radially outward side of the torus-shaped element of the torque converter.

### CROSS REFERENCE TO RELATED APPLICATIONS

This application is based on and claims priority under 35 U.S.C. §119 to Japanese Patent Application 2009-261703, filed on Nov. 17, 2009, and Japanese Patent Application 2009-261704, filed on Nov. 17, 2009, the entire contents of which are incorporated herein by reference.

### TECHNICAL FIELD

This disclosure relates to a torque converter apparatus. In particular, the disclosure pertains to the torque converter apparatus including an impeller clutch and/or a lock-up clutch.

### BACKGROUND DISCUSSION

A known hydraulic torque converter apparatus (torque converter apparatus) disclosed in JP1991-35535B, JP2004-301327A, and JP2008-138877A (hereinafter referred to as References 1, 2, and 3, respectively) includes an impeller clutch engaging and disengaging between an output member (output shaft) of an engine and a pump impeller of a torque converter. In the torque converter apparatus according to References 1, 2, and 3, the impeller clutch is arranged at an outward side of torus-shaped elements of the torque converter in an axial direction of the output member and at an inward side in a radial direction of the torque converter. The torus-shaped elements are formed by a pump impeller, a turbine liner, and a stator wheel. Further, in References 1 and 2, the impeller clutch is positioned in the vicinity of a transmission relative to the torus-shaped elements. Furthermore, in Reference 3, the impeller clutch is positioned in the vicinity of the engine relative to the torus-shaped elements.

According to the hydraulic torque converter apparatus disclosed in References 1, 2, and 3, a pump shell forming an outer shell of the pump impeller is not connected to the impeller clutch by a component of the impeller clutch or the pump shell but by a different member from the component of the impeller clutch or the pump shell.

According to the hydraulic torque converter apparatus described in References 1, 2, and 3, a rear cover (casing, housing) to which torque of the engine is inputted is not connected to the impeller clutch by a component of the impeller clutch or the rear cover but by a different member from the component of the impeller clutch or the rear cover.

According to the hydraulic torque converter apparatus disclosed in Reference 2, an operating fluid via which a clutch engagement pressure is applied to the impeller clutch is fully filled to an approximately outer diameter side of the torque converter, thereby operating the impeller clutch.

According to the hydraulic torque apparatus described in References 1, 2, and 3, the impeller clutch and a lock-up clutch are formed by different components from each other.

In a case where the impeller clutch and the torus-shaped elements of the torque converters are arranged adjacent to one another in the axial direction as in References 1, 2, and 3, the size of the hydraulic torque converter apparatus in the axial direction is increased. As a result, manufacturing costs of the hydraulic torque converter apparatus may be increased. In addition, it may be difficult for the hydraulic torque converter apparatus to be mounted on a vehicle depending on specifications of the vehicle.

In a case where the impeller clutch is connected to the pump shell by the different component from the component of the impeller clutch or the pump shell as in References 1, 2, and 3, the number of components of the hydraulic torque converter apparatus may be increased. In addition, a manufacturing process for connecting the different component to both of the impeller clutch and the pump shell may be required.

Further, in a case where the impeller clutch is connected to the rear cover by the different component from the component of the impeller clutch or the rear cover as in References 1, 2, and 3, the number of components of the hydraulic torque converter apparatus may be increased. In addition, a manufacturing process for connecting the different component to both of the impeller clutch and the rear cover shell may be required.

Furthermore, in a case where the impeller clutch does not operate until the operating fluid via which the clutch engagement pressure is applied to the impeller clutch is fully filled to the approximately outer diameter portion of the inside of the torque converter as in Reference 2, time may be required to establish engaged and disengaged states of the impeller clutch.

Moreover, in a case where the impeller clutch and the lock-up clutch are formed by the different components from each other as in References 1, 2, and 3, the number of components of the hydraulic torque converter apparatus may be increased.

A need thus exists for a torque converter apparatus, which is not susceptible to the drawback mentioned above.

### SUMMARY

According to an aspect of this disclosure, a torque converter apparatus includes a torque converter having a torus-shaped element, and an impeller clutch transmitting and disconnecting a driving force of an engine to and from an input element of the torque converter, the impeller clutch arranged at a radially outward side of the torus-shaped element of the torque converter.

### BRIEF DESCRIPTION OF THE DRAWINGS

The foregoing and additional features and characteristics of this disclosure will become more apparent from the following detailed description considered with the reference to the accompanying drawing, wherein:

FIG. 1 is a cross-sectional view illustrating a configuration of a torque converter apparatus according to a first embodiment of this disclosure;

FIG. 2 is a cross-sectional view illustrating the configuration of a torque converter apparatus according to a second embodiment of the disclosure;

FIG. 3 is a front view of a set block and a reinforcing plate shown in FIG. 1; and

FIG. 4 is a partial cross-sectional view illustrating a modified example of the torque converter apparatus according to the first embodiment shown in FIG. 1.

### DETAILED DESCRIPTION

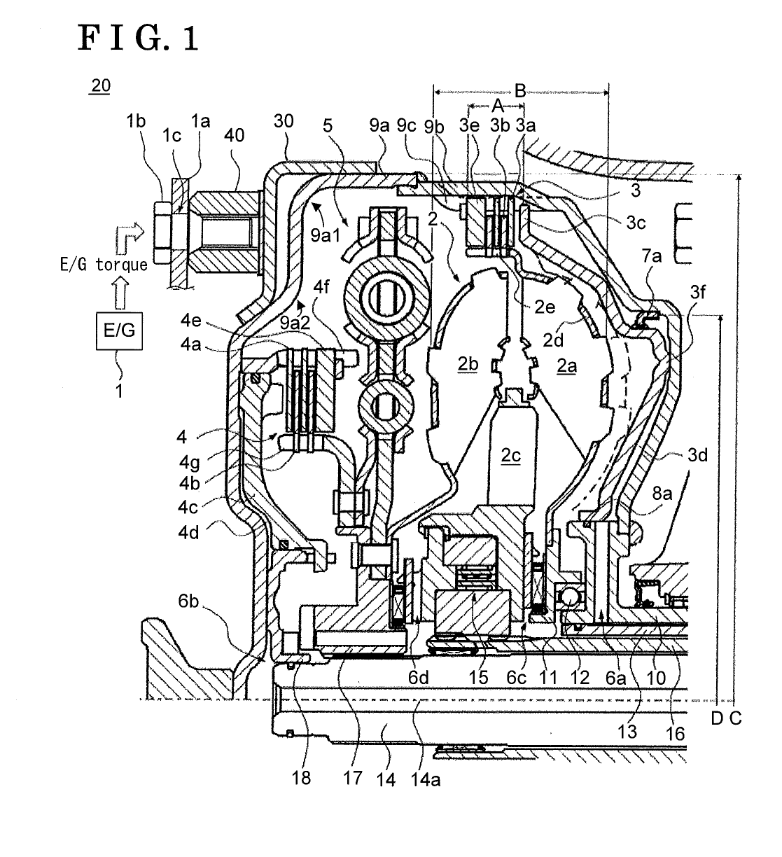

A torque converter apparatus 20 according to a first embodiment of this disclosure will be described as follows with reference to FIG. 1. FIG. 1 illustrates a cross-sectional view illustrating a configuration of the torque converter apparatus 20 according to the first embodiment.

[Basic configuration of the torque converter apparatus] The torque converter apparatus 20 according to the first embodiment includes a torque converter 2, an impeller clutch 3, a lock-up clutch 4, a pump shell 2d, and a cover formed by a front cover 9a and a rear cover 9b. The impeller clutch 3 transmits and disconnects a driving force of an engine 1 to and from a pump impeller 2a (input element) of the torque converter 2. The lock-up clutch 4 transmits and disconnects the driving force between the engine 1 and an output shaft 14 of the torque converter 2. The pump shell 2d forms an outer shell of the pump impeller 2a and rotates integrally therewith. The cover covers the torque converter 2 and the impeller clutch 3. Torque from the engine 1 is transmitted to the cover.

[Lock-up damper] The torque converter apparatus 20 further includes a lock-up damper 5. The lock-up damper 5 is connected between the lock-up clutch 4 and the output shaft 14 so as to absorb variations of the torque of the engine 1 and the like when the lock-up clutch 4 is in an engaged state. The lock-up damper 5 and the torque converter 2 are connected to a turbine hub 17 spline-fitted to the output shaft 14.

[Torque converter] The torque converter 2 includes the pump impeller 2a serving as the input element, a turbine liner 2b serving as an output element, and a stator wheel 2c multiplying the torque transmitted via a fluid between the pump impeller 2a and the turbine liner 2b.

[Cover] The cover includes the front cover 9a connected to an output member (drive plate 1a) arranged in the vicinity of the engine 1 and the rear cover 9b integrally formed with the front cover 9a. The drive plate 1a is positioned at an outer side of the front cover 9a.

[Impeller clutch] The impeller clutch 3 includes first frictional engagement members 3a, second frictional engagement members 3b, a clutch piston 3c, a hydraulic pressure chamber 3d, and a flange 3e. The first frictional engagement members 3a to which the torque is inputted, integrally rotate with the rear cover 9b. The second frictional engagement members 3b integrally rotate with the pump impeller 2a while being engageable with the first frictional engagement members 3a. The clutch piston 3c is moved in an axial direction of the output shaft 14 by means of a clutch engagement pressure supplied to the hydraulic pressure chamber 3d through an independent oil passage 6a, thereby pressing the first frictional engagement members 3a toward the second frictional engagement members 3b. The clutch engagement pressure is supplied and discharged to and from the hydraulic pressure chamber 3d through the independent oil passage 6a. The flange 3e is locked to the rear cover 9b. The first frictional engagement members 3a and the second frictional engagement members 3b are supported between the clutch piston 3c and the flange 3e. When the impeller clutch 3 is brought into a disengaged state, the engine 1 is mechanically disconnected from the torque converter 2 and a transmission; therefore, the engine 1 is allowed to easily start. Meanwhile, when a vehicle shifts from a stopped state to a moving state, the impeller clutch 3 is in the engaged state and the torque converter 2 drives the transmission.

[Lock-up clutch] The lock-up clutch 4 is arranged at a radially inward side of the torque converter 2 or at an intermediate portion in a radial direction of the torque converter 2. The lock-up clutch 4 includes first frictional engagement members 4a, second frictional engagement members 4b, a clutch piston 4c, a hydraulic pressure chamber 4d, and a flange 4e. The first frictional engagement members 4a are supported by an outer hub 4f integrally formed with an inner wall of the front cover 9a. The second frictional engagement members 4b are connected to an inner hub 4g integrally rotating with an input element of the lock-up damper 5 while being engageable with the first frictional engagement members 4a. The clutch piston 4c is moved in the axial direction of the output shaft 14 by means of the clutch engagement pressure supplied to the hydraulic pressure chamber 4d through an independent oil passage 6b, thereby engaging the first frictional engagement members 4a with the second frictional engagement members 4b. The clutch engagement pressure is supplied and discharged to and from the hydraulic pressure chamber 4d through the independent oil passage 6b. The flange 4e is locked to the outer hub 4f. The first frictional engagement members 4a and the second frictional engagement members 4b are supported between the clutch piston 4c and the flange 4e.

[Oil passage] The independent oil passage 6a of the impeller clutch 3 is formed in a rear cover hub 10 (cover hub) so as to extend in a radial direction of the rear cover hub 10. The rear cover hub 10 is connected to a radially inward side of the rear cover 9b. The clutch engagement pressure is supplied to the independent oil passage 6a through a space defined between an inner circumferential surface of the rear cover hub 10 and an outer circumferential surface of a sleeve 13. The independent oil passage 6b of the lock-up clutch 4 is formed between the inner wall of the front cover 9a and a lock-up clutch piston hub 18. The clutch engagement pressure is supplied to the independent oil passage 6b from a hollow oil passage 14a of the output shaft 14. A torque converter oil supply passage 6c is formed between the stator wheel 2c and an impeller hub 11. The impeller hub 11 is connected to a radially inward portion of the pump impeller 2a. In particular, the torque converter oil supply passage 6c is formed between an inner circumferential surface of the sleeve 13 and an outer circumferential surface of a stator wheel shaft 16. The stator wheel shaft 16 supports the stator wheel 2c via a one way clutch 15. A torque converter oil discharge passage 6d is formed between the one way clutch 15 and the turbine hub 17 that is connected to a radially inward portion of the turbine liner 2b. An internal pressure of the torque converter 2 is discharged from the torque converter oil discharge passage 6d through a space defined between an inner circumferential surface of the stator wheel shaft 16 and an outer circumferential surface of the output shaft 14. In addition, the impeller hub 11 is rotatably supported by the rear cover hub 10 via a bearing 12.

[Arrangement of the impeller clutch] The impeller clutch 3 is arranged at a radially outward side of torus-shaped elements (formed by the pump impeller 2a, the turbine liner 2b, and the stator wheel 2c) of the torque converter 2. In particular, an axial length A of the impeller clutch 3 is designed to be shorter than an axial length B of the torus-shaped elements 2a, 2b, and 2c. That is, the impeller clutch 3 is arranged within the axial length B of the torus-shaped elements 2a, 2b, and 2c; therefore, an entire axial length of the torque converter apparatus 20 is shortened. As a result, installability of the torque converter apparatus 20 relative to a vehicle is increased.

[Connection between the impeller clutch and the impeller clutch shell] An end portion at a radially outward side of the pump shell 2d, extends so as to serve as an inner hub 2e supporting the second frictional engagement members 3b included in the impeller clutch 3. The end portion at the radially outward side of the pump shell 2d will be referred to as a radially outward end portion 2e. The second frictional engagement members 3b are spline-fitted to the radially outward end portion 2e of the pump shell 2d so as to integrally rotate therewith. When the impeller clutch 3 is in the engaged state, the torque of the engine 1 is transmitted from the impeller clutch 3 to the pump impeller 2a via the radially outward end portion 2e. Thus, the radially outward end portion of the pump shell 2d, i.e. a portion of the pump shell 2d, serves as the inner hub 2e supporting the second frictional engagement members 3b of the impeller clutch 3. As a result, the number of components of the torque converter apparatus 20 is reduced and man-hours for connecting the impeller clutch 3 to the pump shell 2d are reduced.

[Connection between the impeller clutch and the rear cover] A spline formed at an inner surface of a radially outward side of the rear cover 9b serves as an outer hub 9c supporting the first frictional engagement members 3a included in the impeller clutch 3. Thus, the spline of the inner surface of the radially outward side the rear cover 9b, i.e. a portion of the rear cover 9b, serves as the outer hub 9c. As a result, the number of components of the torque converter apparatus 20 is reduced and man-hours for connecting the impeller clutch 3 to the rear cover 9 are reduced.

[Prevention for rotation of the clutch piston] The outer hub 9c (spline, rotation preventing portion) formed at the rear cover 9b is shaped like a spline while being engaged with or spline-fitted to an end portion at a radially outward side of the clutch piston 3c in a rotating direction of the torque converter 2. Accordingly, the outer hub 9c functions as the rotation preventing portion for preventing the clutch piston 3c from independently rotating. The clutch piston 3c and the rear cover 9b integrally rotate with each other. Consequently, sliding between a seal member 7a and the rear cover 9b and sliding between the seal member 7a, a seal member 8a, and the clutch piston 3c may be prevented to therefore prevent the seal members 7a and 8a from being damaged. The seal members 7a and 8a that will be described below seal the hydraulic pressure chamber 3d formed by the rear cover 9b and the clutch piston 3c. In particular, the seal member 7a seals an outer diameter side of the clutch piston 3c while the seal member 8a seals an inner diameter side of the clutch piston 3c. In addition, the seal members 7a and 8a will be referred to as an outer-diameter-side seal member 7a and an inner-diameter-side seal member 8a, respectively.

[Initial stroke position of the clutch piston] The impeller clutch 3 includes the clutch piston 3c moving between an outer surface of the pump shell 2d of the torque converter 2 and the inner surface of the rear cover 9b of the torque converter 2. The clutch piston 3 includes a contact portion 3f. The contact portion 3f of the clutch piston 3 makes contact with the inner surface of the rear cover 9b to define an initial stroke position of the clutch piston 3c. The torque converter apparatus 20 is configured so that the initial stroke position of the clutch piston 3c is constant when the impeller clutch 3 is in the disengaged state. Accordingly, variations in the time required for bringing the impeller clutch 3 into the engaged and disengaged states are minimized.

[Hydraulic pressure chamber of the impeller clutch, seal for the clutch piston of the impeller clutch] A space to which the clutch engagement pressure is supplied is defined between the clutch piston 3c of the impeller clutch 3 and the inner surface of the rear cover 9b. In the aforementioned space, the outer-diameter-side seal member 7a is arranged between the clutch piston 3c and the inner surface of the rear cover 9b and a void defined at a radially inward side of the outer-diameter-side seal member 7a is the hydraulic pressure chamber 3d of the impeller clutch 3. Meanwhile, the inner-diameter-side seal member 8a is arranged between an end portion at the inner diameter side of the clutch piston 3 and the rear cover hub 10. The inner-diameter-side seal member 8a seals the inner diameter side of the hydraulic pressure chamber 3d. In addition, the outer-diameter-side seal member 7a includes outer and inner surfaces. The outer surface of the outer-diameter-side seal member 7a is in contact with the inner surface of the rear cover 9b in the radial direction while extending in the axial direction of the output shaft 14. The inner surface of the outer-diameter-side seal member 7a is in contact with an outer surface of the clutch piston 3c in the radial direction. The outer-diameter-side seal member 7a moves in accordance with the movement of the clutch piston 3c.

The outer-diameter-side seal member 7a is arranged at an intermediate portion of the aforementioned space between the clutch piston 3c of the impeller clutch 3 and the inner surface of the rear cover 9b in the radial direction so that an inner volume of the hydraulic pressure chamber 3d is reduced. In particular, the position of the outer-diameter-side seal member 7a is set so that a ratio of an outer diameter D of the hydraulic pressure chamber 3d of the impeller clutch 3 relative to an outer diameter C of the torque converter 2 ranges from ⅖ to ⅘. Accordingly, a frictional engagement pressure (clutch engagement pressure) relative to the impeller clutch 3 is surely secured and the time required for bringing the impeller clutch 3 into the engaged or disengaged state is shortened.

[Rounded portion of the cover and reinforcing plate] As shown in FIG. 1, according to the torque converter apparatus 20 of the first embodiment, the torque converter 2 is covered by the cover including at least a rounded portion 9a1 at a radially outward side of the front cover 9a. The cover including the rounded portion 9a1 and a rounded portion 9a2 is formed by the front cover 9a covering a portion of the radially outward side of the torque converter 2, which is located in the vicinity of the engine 1, and the rear cover 9b covering a portion of the radially outward side of the torque converter 2, which is located in the vicinity of the transmission. The rear cover 9b is integrally formed with the front cover 9a.

The torque converter apparatus 20 includes a reinforcing plate 30 and a set block 40 in order to connect the torque converter apparatus 20 to the engine 1. The reinforcing plate 30 is fixed to the front cover 9a by contacting a plurality of portions of the front cover 9a, for example, by welding so as to cover the rounded portions 9a1 and 9a2. The set block 40 is attached by welding to the drive plate 1a. The set block 40 is connected to a facing surface of the reinforcing plate 30, which faces the drive plate 1a.

A plurality of bolt insertion holes 1c is circumferentially formed in a large diameter portion of the drive plate 1a so as to be positioned away from one another at predetermined intervals. A bolt 1b is inserted into each of the bolt insertion holes 1c. In particular, a plurality of reinforcing plates 30 and a plurality of set blocks 40 are applied depending on the number of the bolt insertion holes 1c. A threaded hole with which the bolt 1b is screwed is formed in the set block 40. As illustrated in FIG. 1, the drive plate 1a is supported between the set block 40 and the bolt 1b screwed with the drive plate 1a to thereby connect the torque converter apparatus 20 to the engine 1.

The reinforcing plate 30 is fixed to the front cover 9a by contacting the plurality of portions of the front cover 9a so as to cover the rounded portions 9a1 and 9a2 formed at the radially outward side and a radially inward side, respectively, of the front cover 9a. An inner surface of the reinforcing plate 30 is fixed to an outer surface of the front cover 9a. In particular, the inner surface of the reinforcing plate 30 is in contact with a portion of the outer surface of the front cover 9a, which is positioned at the further radially outward side of the front cover 9a than the rounded portion 9a1. Further, the inner surface of the reinforcing plate 30 is in contact with a portion of the outer surface of the front cover 9a, which is positioned at the further radially inward side of the front cover 9a than the rounded portion 9a2. The rounded portion 9a1 is formed in a convex projecting toward the radially outward side of the front cover 9a. Meanwhile, the rounded portion 9a2 is formed in a convex projecting toward the radially inward side of the front cover 9a.

Effects of the torque converter apparatus 20 described above will be explained as follows with reference to a configuration connecting the torque converter apparatus 20 to the engine 1.

A shape of the reinforcing plate 30 that may be easily manufactured at low cost is modified, for example, by changing the position of the bolt insertion holes 1c; thereby, specifications of the engine 1 may be easily modified. Further, since the specifications of the engine 1 may be modified by changing the shape of the reinforcing plate 30, a shape of the set block 40 that is not manufactured easily at low cost is not necessarily modified to a complicated shape. That is, the set block 40 having the general simple shape processed by a cold forging technique may be applied. The general shape of the set block 40 is for example, of a rectangular or hexagonal shape. In a case where the set block 40 is processed by a hot forging technique, required dimensions of the set block 40 may not be easily obtained because of thermal modifications and the like of a material of the set block 40. In addition, after the material of the set block 40 is processed by the hot forging technique, a cutting process is required for the material, therefore increasing manufacturing costs. Moreover, since the reinforcing plate 30 is fixed to the front cover 9a by contacting the plurality of portions of the front cover 9a so as to cover the rounded portions 9a1 and 9a2 that are weak in strength, the attaching strength of the set block 40 via the reinforcing plate 30 relative to the front cover 9a and the rigidity of the front cover 9a increase. Accordingly, the configuration connecting the torque converter apparatus 20 to the engine 1 according to the first embodiment is applicable to a connecting process for connecting a torque converter apparatus to an engine generating high torque or outputting high rotation speed.

A modified example of the torque converter apparatus 20 according to the first embodiment shown in FIG. 1 will be explained as follows. FIG. 4 is a partial cross-sectional view illustrating the modified example of the torque converter apparatus 20 according to the first embodiment. As shown in FIG. 4, a reinforcing plate 33 having a different shape from the shape of the reinforcing plate 30 according to the first embodiment is applied in the modified example. According to the modified example, a diameter of the drive plate 1a shown in FIG. 1 is enlarged toward the radially outward side and the position of the bolt insertion holes 1c is dislocated toward the radially outward side.

In comparison of FIG. 4 with FIG. 1, a shape of the set block 4 shown in FIG. 4 is identical to the shape of the set block 40 shown in FIG. 1. In FIG. 4, the shape of the reinforcing plate 33 is only modified from the shape of the reinforcing plate 30 shown in FIG. 1. In other words, the reinforcing plate 33 is formed to project toward the radially outward side of the front cover 9a. In addition, the reinforcing plate 33 includes a radially-projecting portion 33a to which the set block 40 is attached.

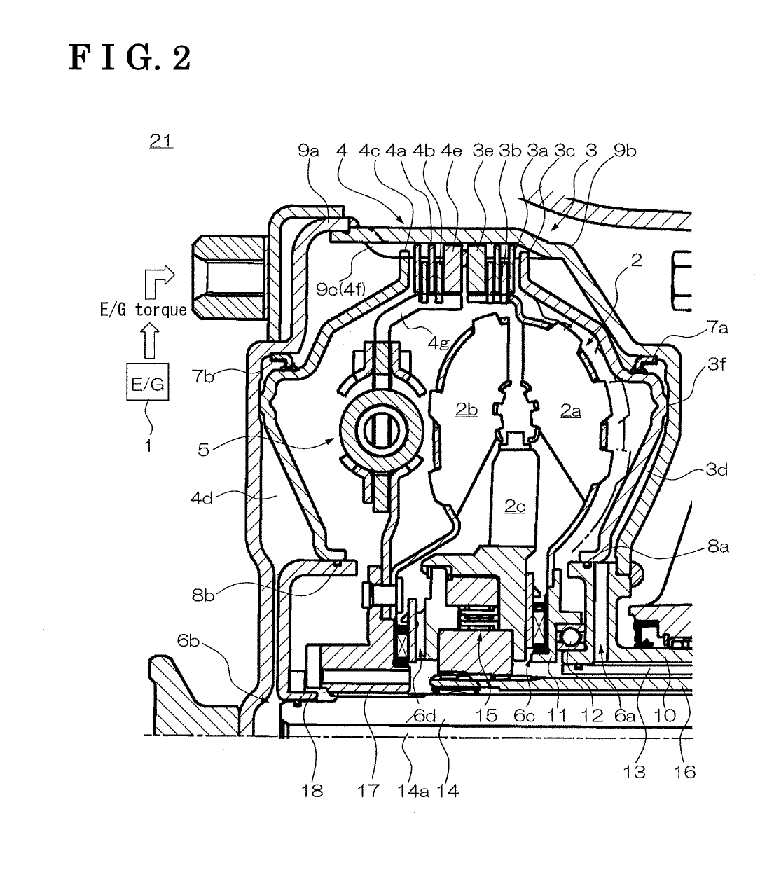

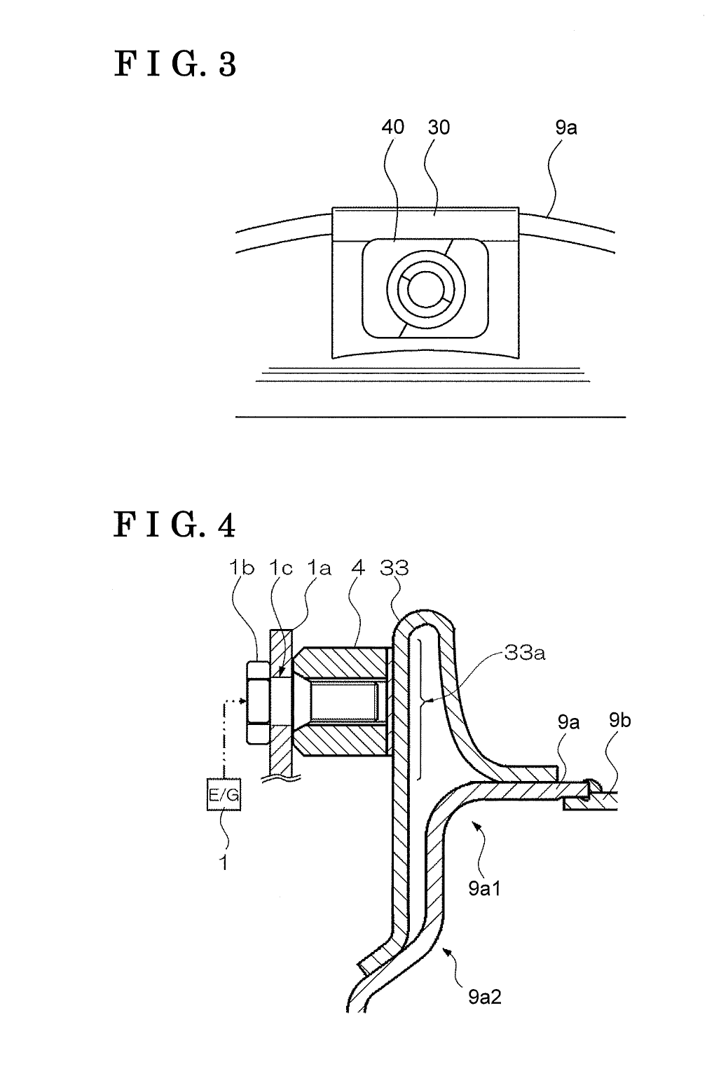

As described above, according to the modified example of the first embodiment, the specifications of the engine 1 may be easily modified only by replacing the reinforcing plate 30 illustrated in FIG. 1 by the reinforcing plate 33 illustrated in FIG. 4. For example, the engine 1 is modified so as to generate high torque or to output high rotation speed; therefore, the diameter of the drive plate 1a shown in FIG. 1 is enlarged and the position of the bolt insertion holes 1c shown in FIG. 1 is dislocated to the radially outward side of the front cover 9a. Such modification may be easily performed by the modified example of the first embodiment.

[Components of the impeller clutch and the lock-up clutch] A torque converter apparatus 21 according to a second embodiment of the disclosure will be explained as follows. FIG. 2 is a cross-sectional view illustrating a configuration of the torque converter apparatus 21 according to the second embodiment. Characteristics of the torque converter apparatus 21 shown in FIG. 2, which are similar to those of the torque converter apparatus 20 of the first embodiment, are shown in FIG. 1. Different characteristics of the torque converter 21 from those of the torque converter 20 will be mainly described in the second embodiment.

As illustrated in FIG. 2, the torque converter apparatus 21 according to the second embodiment includes the torque converter 2, the impeller clutch 3, and the lock-up clutch 4. The impeller clutch 3 transmits and disconnects the driving force of the engine 1 to and from the pump impeller 2a (input element) of the torque converter 2. The lock-up clutch 4 transmits and disconnects the driving force between the engine 1 and the output shaft 14 of the torque converter 2. Each of the impeller clutch 3 and the lock-up clutch 4 is a multiple-disc clutch.

A seal member 7b (which will be hereinafter referred to as an outer-diameter-side seal member 7b) is arranged between the clutch piston 4c and the inner surface of the front cover 9a in a space defined between the clutch piston 4c of the lock-up clutch 4 and the inner surface of the front cover 9a. The clutch engagement pressure is supplied to the space between the clutch piston 4c and the front cover 9a. In addition, a void defined at a radially inward side of the outer-diameter-side seal member 7b in the aforementioned space is the hydraulic pressure chamber 4d of the lock-up clutch 4. The lock-up clutch 4 further includes the lock-up clutch piston hub 18. The lock-up clutch piston hub 18 is locked to an end portion at a radially inward side of the hydraulic pressure chamber 4d and to the output shaft 14 so as to integrally rotate therewith. Further, the lock-up clutch piston hub 18 is engaged in the rotating direction of the torque converter 2 so as to move in the axial direction of the output shaft 14. A seal member 8b (which will be referred to as an inner-diameter-side seal member 8b) is provided between an inner circumferential surface of the clutch piston 4c and an outer circumferential surface of the lock-up clutch piston hub 18. The inner-diameter-side seal member 8b seals the inner diameter side of the hydraulic pressure chamber 4d.

The impeller clutch 3 and the lock-up clutch 4 are arranged in the same position at the radially outward side of the torus-shaped elements 2a, 2b, and 2c of the torque converter 2 while being positioned next to each other in the axial direction of the output shaft 14 at the radially outward side of the torus-shaped elements 2a, 2b, and 2c of the torque converter 2. Accordingly, the impeller clutch 3 and the lock-up clutch 4 are arranged symmetrically in the axial direction. Further, the impeller clutch 3 and the lock-up clutch 4 are formed by common components. Furthermore, other components (peripheral components of the clutch piston 3c and the clutch piston 4c) of the impeller clutch 3 and the lock-up clutch 4, i.e. the first frictional engagement members 3a, 4a (frictional engagement members), the second frictional engagement members 3b, 4b (frictional engagement members), the flanges 3e, 4e, the outer-diameter-side seal members 7a, 7b, and the inner-diameter-side seal members 8a, 8b are arranged symmetrically in the axial direction. The peripheral components of the clutch piston 3c and the clutch piston 4c are standardized.

In addition, in a case where the first frictional engagement members 3a, 4a and/or the second frictional engagement members 3b, 4b are formed by frictional linings and plates, the frictional linings have the same shape and the plates have the same shape.

Thus, the number of components of the impeller clutch 3 and the lock-up clutch 4 is reduced and manufacturing equipments and processes are standardized. As a result, manufacturing costs of the torque converter apparatus 21 are reduced.

The torque converter apparatus 20, 21 according to the first and second embodiments are particularly applied to a torque converter apparatus including an impeller clutch and a lock-up clutch. In addition, the torque converter apparatus 20, 21 is applicable to a vehicle on which the torque converter apparatus including the impeller clutch and the lock-up clutch is mounted.

As describe above, according to the aforementioned first embodiment, the impeller clutch 3 is positioned within the axial length B of the torus-shaped element 2a, 2b, and 2c of the torque converter 2.

Accordingly, the entire axial length of the torque converter apparatus 20 is shortened, therefore increasing the installability relative to the vehicle or reducing the manufacturing costs.

According to the aforementioned first and second embodiments, in the torque converter apparatus 20, 21 further including the pump shell 2d forming the outer shell of the impeller clutch 3 of the torque converter 2 and integrally rotating with the pump impeller 2a, a portion of the pump shell 2d is the inner hub 2e supporting the second frictional engagement members 3b.

Accordingly, the number of components of the torque converter apparatus 20, 21 is reduced. In addition, a manufacturing process for connecting the impeller clutch 3 to the pump shell 2d is not required.

According to the aforementioned first and second embodiments, in the torque converter apparatus 20, 21 further including the cover covering the torque converter 2 and the impeller clutch 3 and receiving the torque from the engine 1, a portion of the cover is the outer hub 9c supporting the first frictional engagement members 3a included in the impeller clutch 3.

Accordingly, the number of components of the torque converter apparatus 20, 21 is reduced. In addition, a manufacturing process for connecting the impeller clutch 3 to the rear cover 9b is not required.

According to the aforementioned first and second embodiments, in the torque converter apparatus 20, 21 further including the pump shell 2d forming the outer shell of the pump impeller 2a of the torque converter 2 and integrally rotating with the pump impeller 2a, and the cover covering the torque converter 2 and the impeller clutch 3 and receiving the torque from the engine 1, the impeller clutch 3 includes the clutch piston 3c moving between the outer surface of the pump shell 2d and the inner surface of the cover (rear cover 9b). The rear cover 9b includes the rotation preventing portion (outer hub) 9c locked to the clutch piston 3c in the rotating direction of the torque converter 2 and preventing the clutch piston 3c from independently rotating.

Accordingly, the clutch piston 3c integrally rotates with the rear cover 9b, therefore preventing the damage of the outer-diameter-side seal member 7a and the inner-diameter-side seal member 8a that seal the hydraulic pressure chamber 3d defined between the rear cover 9b and the clutch piston 3c.

According to the aforementioned first and second embodiments, the clutch piston 3c includes the contact portion 3f making contact with the inner surface of the rear cover 9b to define the initial stroke position of the clutch piston 3c.

Accordingly, the initial stroke position of the clutch piston 3c is constant when the impeller clutch 3 is in the disengaged state. Consequently, the variations in the time for required for bringing the impeller clutch 3 into the engaged and disengaged states are minimized.

According to the aforementioned first and second embodiments, the torque converter apparatus 20, 21 further includes the seal member 7a attached at least between the clutch piston 3c and the rear cover 9b or between the clutch piston 3c that slides on the rear cover hub 10 and the rear cover hub 10 that integrally rotates with the rear cover 9b.

Accordingly, the hydraulic pressure chamber 3d is defined by the outer-diameter-side seal member 7a and the inner-diameter-side seal member 8a while being appropriately sealed by the outer-diameter-side seal member 7a and the inner-diameter-side seal member 8a. In addition, the inner volume of the hydraulic pressure chamber 3d is minimized and the time required for bringing the impeller clutch 3 into the engaged and disengaged state is reduced.

According to the aforementioned first and second embodiments, in the torque converter apparatus 20, 21 further including the pump shell 2d forming the outer shell of the pump impeller 2a of the torque converter 2 and integrally rotating with the pump impeller 2a, and the cover covering the torque converter 2 and the impeller clutch 3 and receiving the torque from the engine 1, the impeller clutch 3 includes the clutch piston 3c moving between the outer surface of the pump shell 2d and the inner surface of the rear cover 9b, and the space to which the clutch engagement pressure is supplied. The clutch engagement pressure allows the clutch piston to move. Further, the seal member 7a is attached between the inner surface of the rear cover 9b and the clutch piston 3c in the space and the void defined at the radially inward side of the seal member 7a in the space is the hydraulic pressure chamber 3d.

According to the torque converter apparatus 20, 21 configured as described above, the time required for filling an operating fluid, which generates the clutch engagement pressure, in the hydraulic pressure chamber 3d is short. Thus, the time required for bringing the impeller clutch 3 into the engaged and disengaged states is shortened and fuel efficiency of the engine 1 is improved. In addition, the hydraulic pressure chamber 3d is appropriately sealed by the outer-diameter-side seal member 7a and the inner-diameter-side seal member 8a.

According to the aforementioned first and second embodiments, the ratio of the outer diameter D of the hydraulic pressure chamber 3d of the impeller clutch 3 relative to the outer diameter C of the torque converter 2 ranges from ⅖ to ⅘.

Accordingly, the impeller clutch 3 is promptly brought into the engaged state and the clutch engagement pressure bringing the impeller clutch 3 into the engaged state 3 is sufficiently obtained.

According to the aforementioned second embodiment, in the torque converter apparatus 21 further including the lock-up clutch 4 transmitting and disconnecting the driving force of the engine 1 to and from the output shaft 14 of the torque converter 2, the clutch piston 3c of the impeller clutch 3 and the clutch piston 4c of the lock-up clutch 4 are symmetrically arranged to each other. The clutch piston 3c of the impeller clutch 3 and the clutch piston 4c of the lock-up clutch 4 are formed to have the same shape.

In addition, other components (peripheral components) of the impeller clutch 3 and the lock-up clutch 4 are standardized. Thus, the clutch pistons 3c, 4c, the first frictional engagement members 3a, 4a, the second frictional engagement members 3b, 4b, and the like are standardized. As a result, the number of components and types of components of the torque converter apparatus 21 are reduced.

According to the second embodiment, the first and second frictional engagement members 3a and 3b of the impeller clutch 3 and the first and second frictional engagement members 4a and 4b of the lock-up clutch 4 are formed to have the same shape.

Thus, the number of components of the torque converter apparatus 21 is reduced.

According to the aforementioned second embodiment, the impeller clutch 3 and the lock-up clutch 4 are provided in the same position in the radial direction of the torus-shaped elements 2a, 2b, and 2c of the torque converter 2 at the radially outward side of the torus-shaped element and positioned adjacent to each other in the axial direction of the output shaft 14 at the radially outward side.

Accordingly, the torque converter apparatus 21 may be formed by the common components and the number of the components may be easily reduced by the arrangement of the impeller clutch 3 and the lock-up clutch 4 as described above.

According to the aforementioned first embodiment, the torque converter apparatus 20 further includes the cover, the reinforcing plate 30, and the set block 40. The cover (front cover 9a) includes at least the rounded portion 9a1 at the radially outward side and covers the impeller clutch 3 and the torque converter 2. The cover receives the torque from the drive plate 1a of the engine 1 and transmits the torque to the torque converter 2. The reinforcing plate 30 is fixed to the front cover 9a by contacting the plurality of portions of the front cover 9a so as to cover the rounded portion 9a1 of the cover. The set block 40 is attached on the facing surface of the reinforcing plate, facing the drive plate 1a of the engine 1. The drive plate 1a is arranged at the outer side of the front cover 9a and connected to the set block 40.

As described above, according to the torque converter apparatus 20 of the first embodiment, the shape of the reinforcing plate 30 that may be easily manufactured at low cost is modified, for example, by changing the position of the bolt insertion holes 1c; thereby, the specifications of the engine 1 may be easily modified. Further, since the specifications of the engine 1 may be modified by changing the shape of the reinforcing plate 30, the shape of the set block 40 that is not manufactured easily at low cost is not necessarily modified to the complicated shape. That is, the set block 40 having the general simple shape processed by the cold forging technique may be applied. The general shape of the set block 40 is for example, of a rectangular or hexagonal shape. In a case where the set block 40 is processed by the hot forging technique, required dimensions of the set block 40 may not be easily obtained because of thermal modifications and the like of the material of the set block 40. In addition, after the material of the set block 40 is processed by the hot forging technique, the cutting process is required for the material, therefore increasing manufacturing costs. Moreover, since the reinforcing plate 30 is fixed to the front cover 9a by contacting the plurality of portions of the front cover 9a so as to cover the rounded portions 9a1 and 9a2 that are weak in strength, the attaching strength of the set block 40 via the reinforcing plate 30 relative to the front cover 9a and the rigidity of the front cover 9a increase. Accordingly, the configuration connecting the torque converter apparatus 20 to the engine 1 according to the first embodiment is applicable to a connecting process for connecting a torque converter apparatus to an engine generating high torque or outputting high rotation speed.

According to the modified example of the aforementioned first embodiment, the reinforcing plate 33 projects toward the radially outward side of the front cover 9a and includes the radially-projecting portion 33a to which the set block 4 is attached.

The shape of the reinforcing plate 30 of the first embodiment is easily processed and modified to the shape of the reinforcing plate 33; therefore, the drive plate 1a arranged in the vicinity of the engine 1 may be easily connected to the torque converter 2 even when a connecting portion between the drive plate 1a of the engine 1 and the torque converter 2 is located at the radially outward side of the front cover 9a.

According to the aforementioned first embodiment, the reinforcing plate 30 is fixed to the front cover 9a by contacting the plurality of portions of the front cover 9a so as to cover the rounded portion 9a1 formed at the outmost side of the radially outward side of the cover.

Accordingly, the strength of the rounded portion 9a1 formed at the outmost side of the radially outward side of the cover is increased.

According to the aforementioned first embodiment, the reinforcing plate 30 is fixed to the front cover 9a by contacting the plurality of portions of the front cover 9a so as to cover the plurality of rounded portions including the rounded portion 9a1 formed at the outmost side of the radially outward side of the cover.

Accordingly, the strength of the rounded portions 9a1 and 9a2 is increased by the reinforcing plate 30.

According to the aforementioned first embodiment, the inner surface of the reinforcing plate 30 is at least in contact with the outer surface of the front cover 9a.

Accordingly, a contact area between the inner surface of the reinforcing plate 30 and the outer surface of the front cover 9a is expanded to therefore increase the strength of the connection between the reinforcing plate 30 and the front cover 9a.

According to the aforementioned first embodiment, the set block 40 is welded to the reinforcing plate 30.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A torque converter apparatus, comprising:
a torque converter including a torus-shaped element; and
an impeller clutch transmitting and disconnecting a driving force of an engine to and from an input element of the torque converter, the impeller clutch arranged at a radially outward side of the torus-shaped element of the torque converter.

2. The torque converter apparatus according to claim 1, wherein the impeller clutch is positioned within an axial length of the torus-shaped element of the torque converter.

3. The torque converter apparatus according to claim 1, further comprising a pump shell forming an outer shell of the input element of the torque converter and integrally rotating with the input element, wherein a portion of the pump shell is an inner hub supporting a second frictional engagement member.

4. The torque converter apparatus according to claim 1, further comprising a cover covering the torque converter and the impeller clutch and receiving torque from the engine, wherein a portion of the cover is an outer hub supporting a first frictional engagement member included in the impeller clutch.

5. The torque converter apparatus according to claim 1, further comprising a pump shell forming an outer shell of the input element of the torque converter and integrally rotating with the input element, and a cover covering the torque converter and the impeller clutch and receiving torque from the engine, wherein the impeller clutch includes a clutch piston moving between an outer surface of the pump shell and an inner surface of the cover, and the cover includes a rotation preventing portion locked to the clutch piston in a rotating direction of the torque converter and preventing the clutch piston from independently rotating.

6. The torque converter apparatus according to claim 5, wherein the clutch piston includes a contact portion making contact with the inner surface of the cover to define an initial stroke position of the clutch piston.

7. The torque converter apparatus according to claim 5, further comprising a seal member attached at least between the clutch piston and the cover or between the clutch piston and a cover hub that integrally rotates with the cover, the clutch piston sliding on the cover hub.

8. The torque converter apparatus according to claim 1, further comprising a pump shell forming an outer shell of the input element of the torque converter and integrally rotating with the input element, and a cover covering the torque converter and the impeller clutch and receiving torque from the engine, wherein the impeller clutch includes a clutch piston moving between an outer surface of the pump shell and an inner surface of the cover, and a space to which a clutch engagement pressure is supplied, the clutch engagement pressure allowing the clutch piston to move, and
wherein a seal member is attached between the inner surface of the cover and the clutch piston in the space, and a void defined at a radially inward side of the seal member in the space is a hydraulic pressure chamber.

9. The torque converter apparatus according to claim 8, wherein a ratio of an outer diameter of the hydraulic pressure chamber of the impeller clutch relative to an outer diameter of the torque converter ranges from ⅖ to ⅘.

10. The torque converter apparatus according to claim 1, further comprising a lock-up clutch transmitting and disconnecting the driving force of the engine to and from an output shaft of the torque converter, wherein a clutch piston of the impeller clutch and a clutch piston of the lock-up clutch are symmetrically arranged to each other, the clutch piston of the impeller clutch and the clutch piston of the lock-up clutch having the same shape.

11. The torque converter apparatus according to claim 10, wherein frictional engagement members of the impeller clutch and the lock-up clutch have the same shape.

12. The torque converter apparatus according to claim 10, wherein the impeller clutch and the lock-up clutch are provided in the same position in a radial direction of the torus-shaped element of the torque converter at the radially outward side of the torus-shaped element and positioned adjacent to each other in an axial direction of the output shaft at the radially outward side.

13. The torque converter apparatus according to claim 1, further comprising a cover, a reinforcing plate, and a set block, the cover including at least a rounded portion at a radially outward side and covering the impeller clutch and the torque converter, the cover receiving torque from an output member of the engine and transmitting the torque to the torque converter, the reinforcing plate being fixed to the cover by contacting a plurality of portions of the cover so as to cover the rounded portion of the cover, the set block being attached on a facing surface of the reinforcing plate, which faces the output member of the engine, the output member being arranged at an outer side of the cover and connected to the set block.

14. The torque converter apparatus according to claim 13, wherein the reinforcing plate projects toward the radially outward side of the cover and includes a radially-projecting portion to which the set block is attached.

15. The torque converter apparatus according to claim 13, wherein the reinforcing plate is fixed to the cover by contacting the plurality of portions of the cover so as to cover the rounded portion formed at an outmost side of the radially outward side of the cover.

16. The torque converter apparatus according to claim 15, wherein the reinforcing plate is fixed to the cover by contacting the plurality of portions of the cover so as to cover a plurality of rounded portions including the rounded portion formed at the outmost side of the radially outward side.

17. The torque converter apparatus according to claim 13, wherein an inner surface of the reinforcing plate is at least in contact with an outer surface of the cover.

18. The torque converter apparatus according to claim 13, wherein the set block is welded to the reinforcing plate.
